(19) United States
(12) Patent Application Publication
(10) Pub. No.: US 2026/0000070 A1
(43) Pub. Date: Jan. 1, 2026

(54) METHODS AND SYSTEMS FOR TISSUE PERFUSION

(71) Applicant: UNIVERSITY OF PITTSBURGH - OF THE COMMONWEALTH SYSTEM OF HIGHER EDUCATION, Pittsburgh, PA (US)

(72) Inventors: Asim EJAZ, Pittsburgh, PA (US); Yusuf SURUCU, Pittsburgh, PA (US); Jose ARELLANO, Pittsburgh, PA (US)

(73) Assignee: UNIVERSITY OF PITTSBURGH - OF THE COMMONWEALTH SYSTEM OF HIGHER EDUCATION, Pittsburgh, PA (US)

(21) Appl. No.: 19/319,207

(22) Filed: Sep. 4, 2025

Related U.S. Application Data
(63) Continuation of application No. PCT/US2024/021293, filed on Mar. 25, 2024.
(60) Provisional application No. 63/458,842, filed on Apr. 12, 2023.

(51) Int. Cl. A01N 1/143; A01N 1/124; A01N 1/126; A01N 1/162

(52) U.S. Cl. CPC A01N 1/143; A01N 1/124; A01N 1/126; A01N 1/162

(57) ABSTRACT

Systems and methods for perfusing the target tissue are provided. The system can include a processor and a bioreactor. The bioreactor includes a media reservoir for storing media, a peristaltic pump for transferring the media, a perfusion chamber for culturing the target tissue with the media, and a plurality of sensors. The perfusion chamber, the peristaltic pump, and the media reservoir are coupled through the tubing. The processor includes an artificial intelligence (AI) module and is configured to generate periodic reports on the metabolic rate of the target tissue through the plurality of sensors and control an operation of the bioreactor for extending a perfusion period.

### CROSS-REFERENCE TO RELATED APPLICATIONS

This application is a continuation of International Patent Application No. PCT/US2024/021293, filed Mar. 25, 2024, which claims the benefit of priority of U.S. Provisional Patent Application No. 63/458,842, filed Apr. 12, 2023, the contents of which are incorporated herein by reference in their entirety, and to which priority is claimed.

### STATEMENT REGARDING FEDERALLY-SPONSORED RESEARCH

This invention was made with government support under grant no. AI153971 awarded by the National Institutes of Health (NIH). The government has certain rights in the invention.

### BACKGROUND

Bioreactors and tissue perfusion techniques are important for clinical and research environments. The tissue perfused in a bioreactor can be used for surgical transplantation and research models for treating various diseases/injuries. For example, tumor models can be categorized as in vitro, in vivo, and ex vivo models. Both in vitro and in vivo models mostly rely on the deconstruction of the tumor, thus resulting in the loss of the tumor microenvironment. Although ex vivo patient-derived explants provide the opportunity to assess the tumor in its microenvironment, artificial culture conditions and disintegration of tissue architecture within a short time frame are the biggest limitations. Genetically engineered mouse models (GEMs) have greatly enhanced the understanding of mechanisms underlying melanoma formation and progression. They offer more physiological melanoma growth dynamics in an immune-competent environment. Additional positives of GEMs are the possibility to perform in vivo imaging, mechanistic studies, and cost-effectiveness. Lack of human relevance, low mutation rates, and anatomic differences to human skin are the biggest limitations of GEMs. Patient-derived xenograft (PDX) models have been employed as an alternative to study human-origin cancer cells in immune-compromised mice. PDX models offer the benefits of human relevance and capture the clinical, histological, and genetic diversity of human melanomas. Lack of immune system, time to establish the xenograft, and high cost of such models are the main downsides. In addition, the replacement of a human tumor stromal component with a mouse and the insertion of mouse retrovirus-mediated mutations results in a more artificial system. Other approaches include growing melanoma cells in vitro in the form of organoids that allow expansion, passaging, banking, and in vitro target identification and drug screening. However, organoids lack tumor microenvironment factors and immune interactions.

Furthermore, due to the lack of proper tissue models, no effective pretreatment or treatments for vesicants injury are available. Such limitations were caused by the lack of focus on addressing the local toxicity of these compounds. In vitro cell toxicity assays and in vivo animal models have been used to understand the mechanism of vesicant-induced pathogenesis and to test mitigation strategies. Variables like culture conditions, media, lack of anatomical orientation, and architectural support and protection make interpreting the data from cell culture models difficult and less reliable. To overcome these constraints, animal models like mice, rats, guinea pigs, rabbits, pigs, and monkeys have been employed to simulate human injuries from vesicants exposure. Comparison of vesicant-induced injuries in different animals and humans revealed differing extents of injury and healing rate, further emphasizing the importance of anatomical architecture and species-specific tissue physiological and pathological responses. Certain researchers used porcine-isolated perfused skin flap is used as a model and maintained flap viability for only up to 8 hours to observe an increase in vascular resistance. Such variable responses of different animals to vesicant-induced injuries highlight the importance of anatomical structures and raise questions about the translation of data. Differences occur in skin thickness, number and distribution of appendages, gland number and architecture, and rete ridge pattern.

The disclosed subject matter directed to full-thickness, human skin perfusion model eliminates these anatomical variables, rigorously analyze the injury mechanism and test mitigators in diverse human population samples (tissue from humans representing different races, age groups and genetic backgrounds). Perfused specimens provide a long-term analysis window (up to three weeks and beyond), and offer enormous flexibility in modulating the environmental and testing conditions such as humidity, temperature, and route of mitigator application (topical, local injection, or systemic).

Therefore, there is a need for an improved platform that can address the limitations of the currently available systems and allow high throughput studies, live imaging, radiographic visualization, and therapeutic applications through the vasculature, mimicking the natural drug delivery route.

### SUMMARY

The disclosed subject matter provides methods and systems for perfusing the target tissue. An example system can include a processor and a bioreactor. The processor can include an artificial intelligence (AI) module. The bioreactor can include a media reservoir for storing media, a peristaltic pump for transferring the media, a perfusion chamber for culturing the target tissue with the media, and a plurality of sensors. In non-limiting embodiments, the perfusion chamber, the peristaltic pump, and the media reservoir can be coupled through a tubing. In certain embodiments, the processor can be configured to generate periodic reports on the metabolic rate of the target tissue through the plurality of sensors and control an operation of the bioreactor using the AI module for extending a perfusion period.

In certain embodiments, the plurality of sensors comprises at least one of a pressure sensor, a flow sensor, a manometer, a pH sensor, a glucose sensor, a lactate sensor, a perfusate Gas sensor, an electrolyte sensor, an infrared thermal camera, a temperature sensor, or combinations thereof.

In certain embodiments, the bioreactor can further include a transfer unit for transferring the target tissue, a catheter, a visible light spectrum camera, a gas exchanger, a luer connector, and a heater for adjusting the temperature of the media. The processor can be configured to control the operation of the transfer unit, the visible light spectrum camera, the gas exchanger, and the heater.

In non-limiting embodiments, The system of claim 1, the periodic reports on the metabolic rate can be generated based on information obtained through the plurality sensors. The information can include lactate and glucose levels, pH levels, perfusate gas, electrolyte levels, arterial and venous flow rates, or combinations thereof.

In certain embodiments, the processor can be configured to report an error that arises due to an operator or equipment failure. In non-limiting embodiments, the processor can be configured to automatically protect the target tissue based on a predetermined protocol or one or more machine-learning models of the AI module. The predetermined protocol is configured to minimize failure risk. The one or more machine-learning models comprise at least a deep learning algorithm. In non-limiting embodiments, the processor can be configured to visually track a perfusion area via the infrared thermal camera.

In certain embodiments, the AI module can be configured to calculate a perfusion area, a media volume, a pump efficiency, an error that leads to a perfusion failure, or combinations thereof. In non-limiting embodiments, calculating the perfusion area, the media volume, the pump efficiency, the error that leads to the perfusion failure, or combinations thereof can be based on one or more inputs to the AI module, and wherein the one or more inputs comprise one or more of a flow rate, a pressure reading, a temperature reading, a CO2 saturation reading, a pH reading, or a number of bubbles. In non-limiting embodiments, the error can include an inline air, an excessive pressure, an edema, a deepithelization, a skin color change, an infection, or combinations thereof.

In non-limiting embodiments, controlling the operation of the bioreactor using the AI module can include receiving, by the AI module, one or more sensor signals from one or more first sensors of the plurality of sensors, determining, by the AI module, one or more operating instructions for one or more of the peristaltic pump or one or more of the sensors, and sending, by the AI module to the one or more of the peristaltic pump or one or more of the sensors, the one or more operation instructions.

In certain embodiments, the media can include an active agent. In non-limiting embodiments, the active agent can include an anti-inflammatory agent. In non-limiting embodiments, the anti-inflammatory agent can include prednisone, prednisolone, cortisone, hydrocortisone, triamcinolone, dexamethasone, mometasone, or a combination thereof.

In certain embodiments, the target tissue can include a skin, a flap, a tumor, a cancer, or combinations thereof.

In certain embodiments, the media can include Dulbecco's Modified Eagle Medium (DMEM) with bovine serum albumin (BSA) for maintaining the tissue architecture.

The disclosed subject matter provides methods for perfusing a target tissue. An example method can include transferring the target tissue to a bioreactor with media and controlling the operations of the bioreactor. The bioreactor can include a bubble trapping system, a heater, and a gas exchanger system. The operation of the bubble trapping system, the heater, and the gas exchanger system can be controlled to control temperature, humidity, and air infusion in the bioreactor for maintaining a sterility, a cannulation of a vascular structure of the target tissue, pH levels, osmolarity, or combinations thereof. In non-limiting embodiments, the operations of the bubble trapping system, the heater, and the gas exchanger system can be controlled by a processor, including an artificial intelligence (AI) module.

In certain embodiments, the methods can include treating the target tissue with a sterilizing agent to prevent infections. In non-limiting embodiments, the method can include infusing an active agent into the bioreactor. The active agent can include an anti-inflammatory agent.

In certain embodiments, the method can include generating periodic reports on a metabolic rate based on an analysis of information obtained through a plurality of sensors by the AI module. The information can include lactate and glucose levels, pH levels, perfusate gas, electrolyte levels, arterial and venous flow rates, or combinations thereof. In non-limiting embodiments, the method can include perfusing the target tissue at least for 1 days.

The purpose and advantages of the disclosed subject matter will be set forth in and are apparent from the description that follows, as well as will be learned by practice of the disclosed subject matter. Additional advantages of the disclosed subject matter will be realized and attained by the devices particularly pointed out in the written description and claims hereof, as well as from the appended drawings.

### BRIEF DESCRIPTION OF THE DRAWINGS

FIG. 1 is a diagram illustrating an example perfusion device in accordance with the disclosed subject matter.

FIG. 2 is a diagram illustrating an example tissue and an example vasculature for perfusion.

FIG. 3 is a fluorescein angiography image showing that the disclosed cannulation and perfusion through the superior inferior epigastric artery (SIEA)/superior inferior epigastric vein (SIEV) system can result in 80-90% tissue area being perfused.

FIGS. 4A-4B are images illustrating example anatomical and histological tissue architectures maintained by the disclosed subject matter.

FIG. 5 provides confocal microscopy images of example tissue sections, which include about 95% of healthy cells.

FIG. 6 provides graphs illustrating the glucose utilization and lactate production by the tissue perfused by the disclosed subject matter.

FIG. 7 is a diagram illustrating example techniques for analyzing cells isolated from the tissue perfused by the disclosed subject matter.

FIG. 8 provides graphs showing the maintenance of vascular physiological response to stimulus maintained by the disclosed subject matter reflected by changes in pressure and flow rate after perfusion.

FIG. 9 provides graphs showing a physiological lipolytic activity of full-thickness skin tissue maintained by the disclosed subject matter reflected by the level of triglyceride, non-essential free fatty acids, and glycerol in the disclosed perfusion media upon stimulus.

FIG. 10 provides immunofluorescence staining images showing the health of adipocytes of the perfused tissue.

FIG. 11 provides images showing an example method for treating the perfused tissue with vesicant.

FIG. 12 provides images showing that transepidermal water loss can be prominent as early as 30 minutes post-application, indicated by a white star.

FIG. 13 is a fluorescein angiography image of the tissue on day 12 of perfusion.

FIG. 14 provides histology images showing perivascular and interstitial lymphocytic inflammation in NM-treated skin specimens.

FIGS. 15A and 15B provide images and a graph showing a gradual increase in TUNEL-positive (Red) cells with the epithelial cells in NM-treated skin patch positive by 200 hr.

FIG. 16 provides images showing an increase in the poly(ADP-ribose) polymerase (PARP)-positive cells.

FIG. 17 provides graphs showing inflammation and apoptotic gene responses from the perfused tissue.

FIG. 18 provides Masson's Trichrome strain images showing epidermal, dermal separation and accumulation of collagens in 20 and 40 Gy irradiated skin patches on day 12 post-irradiation.

FIG. 19 is an image showing the integration and tumorigenesis of MCF-7 cells at day 6 post-inoculation.

FIG. 20 provides histology images showing the immune call infiltration upon tumor cell injection into the perfused tissue.

FIG. 21 provides fluorescein images showing the presence of proliferating tumor cells in the perfused tissue.

### DETAILED DESCRIPTION

The presently disclosed subject matter provides systems and methods for perfusing a target tissue. The system can include a bioreactor for containing the target tissue and a processor that can control the operation of the bioreactor.

For clarity of description, and not by way of limitation, the detailed description of the invention is divided into the following subsections:
6.1 Definitions;
6.2 Perfusion system; and
6.3 Methods of perfusing the target tissue for an extended period.

### 6.1. Definitions

As used herein, the following terms have the meanings ascribed to them below unless specified otherwise. Abbreviations used herein have their conventional meaning within the chemical and biological arts.

As used in the specification and the appended claims, the singular forms “a,” “an,” and “the” include plural referents unless the context clearly dictates otherwise. Thus, for example, a reference to “a compound” includes mixtures of compounds.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

The term “active agent” refers to an agent that is capable of having a physiological effect when administered to a subject. In certain embodiments, the term “active agent” refers to an agent that can modulate the inflammation of a subject or target tissue.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The present disclosure also contemplates other embodiments “comprising,” “consisting of,” and “consisting essentially of,” the embodiments or elements presented herein, whether explicitly set forth or not.

The term “effective amount,” as used herein, refers to the amount of active agent sufficient to treat, prevent, or manage a disease. Further, a therapeutically effective amount with respect to the second targeting probe of the disclosure can mean the amount of active agent alone or in combination with other therapies that provide a therapeutic benefit in the treatment or management of the disease, which can include a decrease in the severity of disease symptoms, an increase in frequency and duration of disease symptom-free periods, or a prevention of impairment or disability due to the disease affliction. The term can encompass an amount that improves overall therapy, reduces or avoids unwanted effects, or enhances the therapeutic efficacy of or synergies with another therapeutic agent.

As used herein, the terms “prevent,” “preventing,” “prevention,” “prophylactic treatment,” and the like refer to reducing the probability of developing a disorder or condition in a subject who does not have but is at risk of or susceptible to developing a disorder or condition. The prevention can be complete (i.e., no detectable symptoms) or partial so that fewer symptoms are observed than would likely occur absent treatment. The terms further include a prophylactic benefit. For disease or condition to be prevented, the compositions can be administered to a patient at risk of developing a particular disease or to a patient reporting one or more of the physiological symptoms of a disease, even though a diagnosis of this disease cannot have been made.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either endpoint of the range are specifically contemplated. For example, a nested sub-range of an exemplary range of 1 to 50 can include 1 to 10, 1 to 20, 1 to 30, and 1 to 40 in one direction, or 50 to 40, 50 to 30, 50 to 20, and 50 to 10 in the other direction.

A “subject” may be a human or a non-human animal, for example, but not by limitation, a non-human primate, a dog, a cat, a horse, a rodent, a cow, a goat, a rabbit, a mouse, etc.

The terms “treat,” “treating,” or “treatment,” and other grammatical equivalents as used herein include alleviating, abating, ameliorating, or preventing a disease, condition or symptoms, preventing additional symptoms, ameliorating or preventing the underlying metabolic causes of symptoms, inhibiting the disease or condition, e.g., arresting the development of the disease or condition, relieving the disease or condition, causing regression of the disease or condition, relieving a condition caused by the disease or condition, or stopping the symptoms of the disease or condition. The terms further include achieving a therapeutic benefit and/or a prophylactic benefit. Therapeutic benefit is meant eradication or amelioration of the underlying disorder being treated. Also, a therapeutic benefit is achieved with the eradication or amelioration of one or more of the physiological symptoms associated with the underlying disorder such that an improvement is observed in the patient, notwithstanding that the patient can still be afflicted with the underlying disorder.

### 6.2. Perfusion System

Reference will now be made in detail to the various exemplary embodiments of the disclosed subject matter, which are illustrated in the accompanying drawings.

The presently disclosed subject matter provides a system and method for perfusing tissue for an extended period.

In certain embodiments, the system for perfusing tissue can include a bioreactor and a processor. The bioreactor can be configured to contain tissue and perfuse the tissue for a predetermined period. For example, the bioreactor can include a media reservoir, a peristaltic pump, a perfusion chamber, and/or a plurality of sensors. The perfusion chamber, the peristaltic pump, and the media reservoir(s) can be coupled or connected through the tubing.

In certain embodiments, the media reservoir can be configured to contain a predetermined volume of media and circulate the media. For example, the media reservoir(s) can store solutions, media, or any liquids up to 10 L. In non-limiting embodiments, the media reservoir can include at least one inlet and at least one outlet. The media reservoir can be configured to receive solutions, media, or any liquids through the inlet and circulate the media through the outlet. In some embodiments, the media reservoir can include at least one opening. A user can remove or replace the media through the opening. A user can also add new solutions, media, or any liquids through the opening. In non-limiting embodiments, a user can add an active agent and/or any chemicals to the media through the opening or connected tubing.

In certain embodiments, the media can be perfusing media for perfusing the target tissue. The perfusing media can include any culture media and any supplements. For example, the perfusing media can include Dulbecco's Modified Eagle Medium (DMEM) with 5 g/dL bovine serum albumin (BSA) for maintaining the tissue architecture. In non-limiting embodiments, the media can be modified or optimized depending on the type of target tissue. For example, the media can further include gentamycin, ciprofloxacin, amphotericin B, fluconazole, hydrocortisone, or combinations thereof. The concentration of the supplements can vary depending on the type of tissue.

In certain embodiments, the media can include an effective amount of an active agent. For example, the active agent can include a therapeutic drug, an anti-inflammatory agent, or a combination thereof. Non-limiting exemplary anti-inflammatory agents that can be used with the presently disclosed methods include prednisone), prednisolone, cortisone, hydrocortisone, triamcinolone, dexamethasone, mometasone or a combination thereof in the range of about 0.001-about 0.1 M. Non-limiting exemplary anti-inflammatory agents can also include NSAID, such as salicylic acid, indomethacin, sodium indomethacin trihydrate, salicylamide, naproxen, colchicine, fenoprofen, sulindac, diflunisal, diclofenac, indoprofen, sodium salicylamide; an anti-inflammatory cytokine; an anti-inflammatory protein; a steroidal anti-inflammatory.

In certain embodiments, the therapeutic agents can be any agents or treatments that can alleviate, abate, ameliorate, or prevent a disease, condition or symptoms of the tissue in the bioreactor. Non-limiting exemplary therapeutic agents can include anti-cancer drugs, ROS (reactive oxygen species) scavengers, anti-oxidants, anti-inflammatory agents, immune suppressors, immune activators, antibodies, cells, plant extracts etc.

In certain embodiments, the media can include a substance that can stimulate the tissue in the bioreactor. In non-limiting embodiments, additional substances for generating a disease or an injury model can be included in the media. For example, vesicant (e.g., nitrogen mustard), allergens (e.g., dust, pollens extracts, proteins etc.), immune activators (e.g., compound 48/80, immune suppressors (e.g., hydrocortisone), collents (e.g., ethanol) can be added to the media to stimulate the tissue in the bioreactor. By treating the tissue with a therapeutic agent after causing injury, the effects of the therapeutic agent can be assessed using the disclosed subject matter.

In certain embodiments, the system can include a perfusion chamber. The perfusion chamber is configured to contain and perfuse the target tissue with the disclosed media. In non-limiting embodiments, the dimension of the chamber can be 17×22×4 inch (W×L×H) made from plexiglass. In non-limiting embodiments, the perfusion chamber is configured to maintain conditions of the target tissue and/or the media for perfusing the target tissue for a predetermined period. For example, the conditions can include humidity, temperature, flow rate, pH, sterility, osmolarity, pressure, CO2 saturation, air infusion, or combinations thereof. In non-limiting embodiments, the perfusion condition can vary depending on the type of tissue. For example, for flap tissues, the chamber is configured to maintain the flow rate (e.g., about 5-6 ml/min), pressure (e.g., 50-70 mmHg), pH (e.g., 7.3-7.5), CO2 saturation (e.g., ˜5%), temperature (e.g., 36-38 C), humidity (70-80%) and no bubbles in the perfusate flow. Bubbles can be removed from the perfusate flow by the disclosed bubble trap. In non-limiting embodiments, the bubble trap can include plexiglass)

In certain embodiments, the bioreactor can include at least one peristaltic pump. The pump can be configured to circulate the media. For example, the perfusion chamber, the peristaltic pump, and the media reservoir are coupled through the tubing, and the pump can circulate the media between the reservoir and chamber through the tube. In non-limiting embodiments, the pump can be configured to maintain the flow rate at the predetermined rate (e.g., about 5-6 ml/min).

In certain embodiments, the tubing can include polyethylene, PVC, Santoprene, Solva, silicon, and Viton. The inner diameter of the tubing can range from 1 mm to about 5 cm. In non-limiting embodiments, the inner diameter can range from about 2.5 mm to about 3 mm.

In certain embodiments, the plurality of sensors can include a pressure sensor, a flow sensor, a manometer, a pH sensor, a glucose sensor, a lactate sensor, a perfusate gas sensor, an electrolyte sensor, a thermal infrared camera, a temperature sensor, or combinations thereof. In non-limiting embodiments, the sensors can be placed at any location on the disclosed system. For example, the sensors can be placed on bioreactor, tubing, or combinations thereof.

In certain embodiments, the system can include at least one transfer unit, a catheter, a visible light spectrum camera, a gas exchanger, a luer connector, a heater, or combinations thereof. The transfer unit can allow the tissue to be transferred around in a sterile contained way for diagnostics and manipulations. The catheter can allow perfusion through the vasculature. The visible light spectrum camera can be used for image processing and machine learning. The gas exchanger can be used for media oxygenation. The luer connector can be used for fluid directional control, the extension of tubing, sampling, and injection of solution). The heater can be used to maintain the temperature and humidity of the perfusion media and tissue. The gas exchanger can be configured to maintain the CO2 saturation at a predetermined level (e.g., ˜ about 5%). The heartier can be configured to maintain the temperature at a predetermined level (e.g., 36-38 C).

In certain embodiments, the processor can include an artificial intelligence (AI) module that can control the operation of the bioreactor. In certain embodiments, the AI module can analyze one or more inputs to the AI module for systematic control of one or more sensors and/or devices. As an example and not by way of limitation, the one or more inputs can comprise one or more of a flow rate, a pressure reading, a temperature reading, a CO2 saturation reading, a pH reading, or a number of bubbles in the flow through. Based on the analysis of these inputs, the AI module can control one or more sensors and/or devices. As an example and not by way of limitation, such sensors and/or devices can comprise one or more of a peristaltic pump, a heating pad, or an oxygen exchanger. In one example embodiment, the pressure readings can be fed to the AI module and will be kept constant in the range of 40-60 mm of Hg to be changing the flow rate. In another example embodiment, the flow sensors and temperature sensors can feed the readings to the AI module and through a feedback loop, the AI module can control the pump and heating sensors. All the data from the perfusion runs can be saved, downstream tissue analysis can be performed, and a learning algorithm can be established that can control the perfusion system working as more and more data can be collected.

In certain embodiments, the AI module can control these sensors and/or devices to correct any out-of-range parameters, making them to be within the desired parameter ranges. In certain embodiments, the desired parameter ranges can be as follows. The desired flow rate range can be 5-6 ml/min. The desired pressure range can be 50-70 mmHg. The desired pH range can be 7.3-7.5. The desired CO2 saturation can be approximately 5%. The desired temperature range can be 36-38 degrees Celcius. The described number of bubbles can be no bubbles in the perfusate flow. The image processing can be integrated into the disclosed system, and these image processing parameters can be controlled by the disclosed AI system to control the pump to stop the infusion of any bubbles in the vasculature.

In certain embodiments, the AI module can comprise one or more machine-learning models. As an example and not by way of limitation, the machine-learning models can be based on deep learning, e.g., convolutional neural networks.

In certain embodiments, the processor can be configured to generate periodic reports on the metabolic rate of the target tissue. The processor can obtain the metabolic rate information through the plurality of sensors and control the operation of the bioreactor for extending a perfusion period by controlling the metabolic rate. For example, the disclosed system can create periodic reports on tissue metabolic rates based on lactate and glucose levels, pH levels, perfusate gas and electrolyte levels, and arterial and venous flow rates. Any error which can arise due to operator or equipment failure is promptly reported (e.g., to the response team). This feature can be governed by the disclosed AI. Through modulation of the underlying parameters, the disclosed system can maintain the optimal condition for tissue perfusion. For example, any change in the pH level can be corrected via the regulation of the gaseous exchange through an increase or decrease of the Co2 infusion.

In non-limiting embodiments, the processor can automatically take precautions to protect the perfused tissue acting on its predetermined protocol and deep learning algorithm. The processor can control the operation of the bioreactors and sensors based on the protocol and/or risk algorithm. By controlling the operation, the disclosed system can minimize the failure risk, allows researchers to have automated reports, and diminishes the operator training requirements and need for human intervention, thus reducing contamination risk and cost.

In certain embodiments, the processor can be configured to control the operation of the transfer unit, the visible light spectrum camera, the gas exchanger, and the heater. For example, the processor can utilize the disclosed camera systems to track the perfusion area via infrared systems visually, and AI guided visual recognition system calculates perfusion area, media volume, pump efficiency, and any error which can lead to perfusion failure like inline air, excessive pressure, edema, deepithelization, skin color changes, possible infection risk.

### 6.3. Methods of Perfusing Target Tissue

The disclosed subject matter provides techniques for perfusing tissue for an extended period. An example method can include transferring the target tissue to a bioreactor with media and controlling the operation of the bioreactor.

In certain embodiments, the target tissue can be transferred to the bioreactor in a way to maintain the tissue architecture. For example, the disclosed method can include securing the superficial inferior epigastric vein and artery, deep inferior epigastric veins and arteries, superficial circumflex iliac artery of the tissue via tying with sutures, clamping, gently preventing blood loss with any equipment. In non-limiting embodiments, the tissue can be transferred to a sterile hard container, covering it with a sterile tight seal bag and maintaining physiological temperature.

In certain embodiments, the bioreactor can include a bubble trapping system, a heater, and a gas exchanger system, and the method can include controlling the operations of them to control temperature, humidity, and air infusion in the bioreactor for maintaining sterility, cannulation of a vascular structure of the target tissue, pH levels, osmolarity, or combinations thereof. For example, the information related to temperature, humidity, air infusion, sterility, cannulation of a vascular structure of the target tissue, pH levels, osmolarity, or combinations thereof can be obtained through a plurality of sensors. The sensors can include a pressure sensor, a flow sensor, a manometer, a pH sensor, a glucose sensor, a lactate sensor, a perfusate gas sensor, an electrolyte sensor, an infrared thermal camera, a temperature sensor, or combinations thereof. In non-limiting embodiments, the sensors can be placed at any location on the disclosed system. For example, the sensors can be placed on bioreactor, tubing, or combinations thereof. In non-limiting embodiments, the tissue can be maintained under HEPA filtered sterile environment to maintain the sterility, cannulation of the vascular structure, temperature, and humidity within physiological ranges. For example, the prevention of air infusion can be achieved via bubble-trapping systems. Regulating pH and gas exchange can be achieved via gas exchanger systems. Balancing the media content can be achieved via infusing buffers. Regulating tissue responses can be achieved via the infusion of drugs and chemicals. Various chemical and mechanical sensor systems can be used to monitor tissue metabolism and perfusion success. Off-loading the flap pedicle and suspending the flap on a grill can be performed to collect capillary outflow to use for re-infusion.

In certain embodiments, the method can include the target tissue with a sterilizing agent to prevent infections. The sterilizing agent can include povidone-iodine, ethanol, chlorhexidine Gluconate, or combinations thereof.

In certain embodiments, the method can include infusing an active agent and or a stimulus into the bioreactor. In non-limiting embodiments, the active agent can include a therapeutic agent and/or an anti-inflammatory agent. Non-limiting exemplary anti-inflammatory agents that can be used with the presently disclosed methods include prednisone, prednisolone, cortisone, hydrocortisone, triamcinolone, dexamethasone mometasone or a combination thereof. In non-limiting embodiments, the concentration of the anti-inflammatory agent can range from about 0.001 M to about 0.1 M Non-limiting exemplary anti-inflammatory agents can also include NSAID, such as salicylic acid, indomethacin, sodium indomethacin trihydrate, salicylamide, naproxen, colchicine, fenoprofen, sulindac, diflunisal, diclofenac, indoprofen, sodium salicylamide; an anti-inflammatory cytokine; an anti-inflammatory protein; a steroidal anti-inflammatory. In certain embodiments, therapeutic agents can be any agents or treatments that can alleviate, abate, ameliorate, or prevent a disease, condition, or symptoms of the tissue in the bioreactor. Non-limiting exemplary therapeutic agents can include anti-cancer drugs. In non-limiting embodiments, the concentration of the therapeutic agent can range from about 0.001 to about 0.1 M. Non-limiting exemplary stimulus can include vesicant (e.g., nitrogen mustard), allergens (e.g., dust, pollens extracts, proteins, etc.), immune activators (e.g., compound 48/80, immune suppressors (e.g., hydrocortisone), collents (e.g., ethanol), or combinations thereof.

In certain embodiments, the method can further include generating periodic reports on a metabolic rate based on information obtained through a plurality of sensors. The information can include lactate and glucose levels, pH levels, perfusate gas, electrolyte levels, arterial and venous flow rates, or combinations thereof. In non-limiting embodiments, the report can be generated by the disclosed AI algorithm.

In certain embodiments, the target tissue can include a flap, skin, tumor, cancer, limb, bone, liver, lymph node, spleen or combinations thereof.

In certain embodiments, the predetermined perfusion date can be at least one day, at least two days, at least three days, at least four days, at least five days, at least six days, at least seven days, at least eight days, at least nine days, at least ten days, at least two weeks, or at least twenty days.

The disclosed subject matter allows the extended perfusion period compared to existing devices or techniques. For example, the disclosed subject matter can provide up to 20 days of perfusion and beyond without perfusion failure or tissue damage. Clinical and preclinical use of the disclosed devices can also alleviate the complicated operational burden of a perfusion unit. Fascio cutaneous flaps are commonly used for reconstructive microsurgery operations to close or reshape an affected field. As the nature of these operations, flaps can be subjected to cold ischemia until the recipient site is prepped. Prolonged ischemia can cause serious reperfusion injury to the implanted tissue, most notably to the endothelium, thus increasing the risk of flap failure due to thrombosis. Ex-vivo perfusion of medical waste tissue from body contouring operations such as abdominoplasties is also possible. The disclosed system can preserve the viability and functionality of an abdominal flap for 20 days and beyond ex vivo (e.g., in a lab environment). Prolonged perfusion can be achieved by non-blood perfusion and mainly used as a full-thickness tissue model for metabolic and injury-based assessments. This achievement can be significant because it is a one-of-a-kind approach to testing drugs in full-thickness human tissues. There are several approaches to researching human tissues, like skin graft explanation culture, organs on a chip, and isolated cell culture. Yet, these have significant limitations that the disclosed system can overcome. The disclosed system can provide the opportunity to perform systemic studies, disease modeling, and drug discovery in a tissue that has a natural microenvironment and anatomy provided by multiple cell types integrated into a natural anatomical arrangement. The disclosed system can inline metabolic sensors for blood gases, electrolytes, and metabolites. Additionally, the disclosed method can include camera systems to track the perfusion area via infrared systems visually, and AI guided visual recognition system calculates perfusion area, media volume, pump efficiency, and any error which may lead to perfusion failure like inline air, excessive pressure, edema, deepithelization, skin color changes, possible infection risk.

In certain embodiments, the disclosed systems and techniques can be used for various applications. In non-limiting embodiments, the disclosed systems can be used for generating an injury or disease, or chemical/drug testing model. For example, the disclosed systems can be used for allergy testing, cosmetic testing, or anti-aging drug testing. A model can be developed by perfusing target tissue with a predetermined condition (e.g., culturing with an agent that can cause the targeted condition or adjusting bioreactor parameters to cause a targeted condition). In non-limiting embodiments, the disclosed systems can be used for drug development. For example, a target drug or active agent can be added to the disclosed system to treat the injury or disease model created by the disclosed subject matter. The metabolic functions of the tissue and therapeutic effects of the drug can be assessed before and/or during and/or after the treatment.

### EXAMPLES

### Example 1: Establishment of a Whole-Thickness Human Skin Perfusion Model

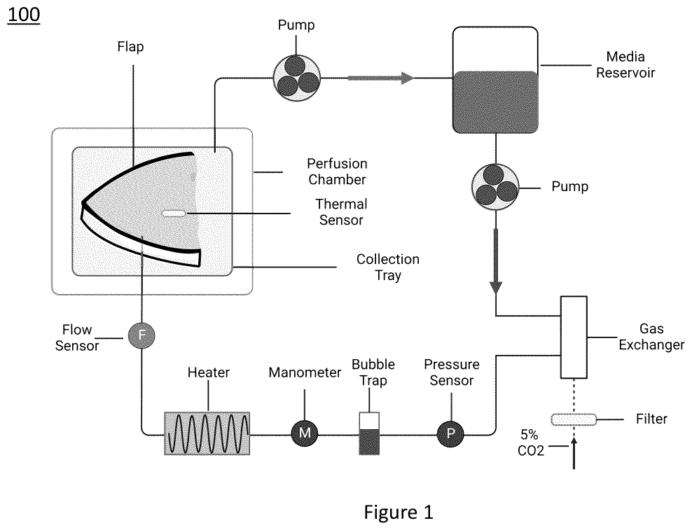

SIEA (superior inferior epigastric artery) and SIEV (superior inferior epigastric vein) perforator system was employed to successfully perfuse panniculectomy tissue in vitro. An overview of the disclosed perfusion system design is shown in FIG. 1. Full-thickness human skin pannus tissues (average size ˜12×14 inches) were obtained as de-identified surgical waste from plastic surgery abdominoplasty procedures.

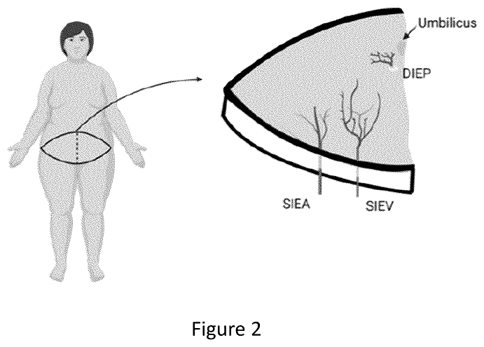

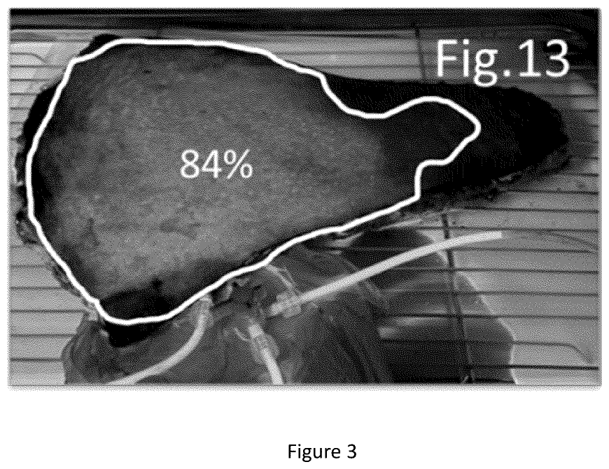

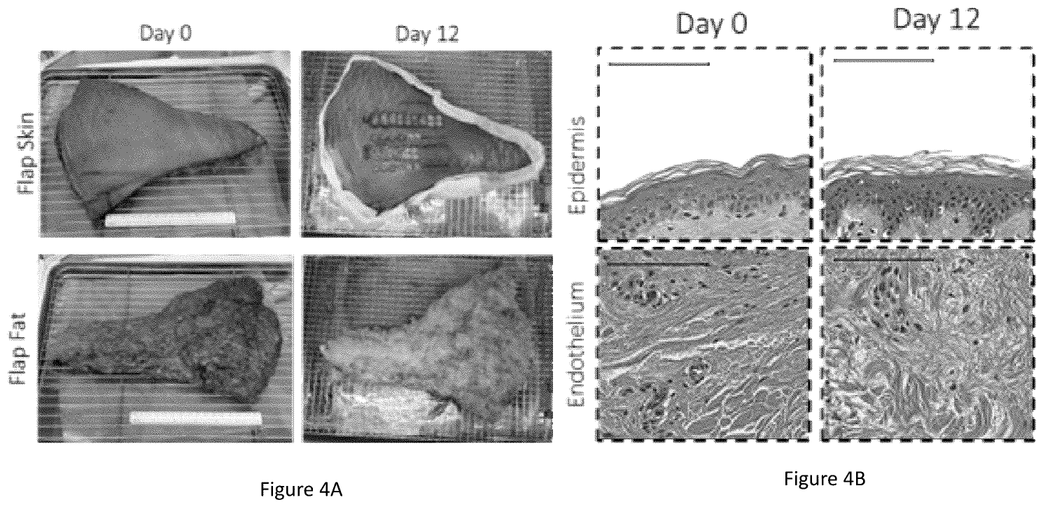

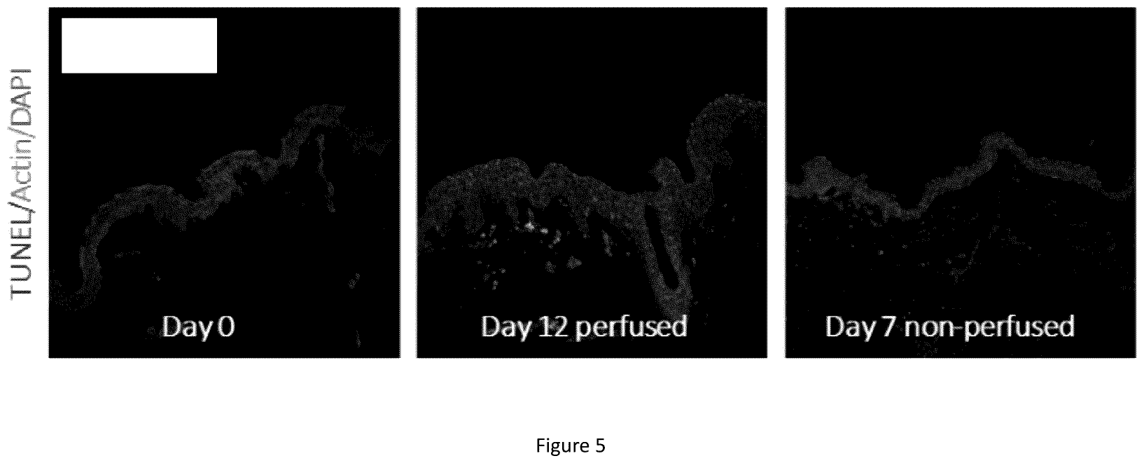

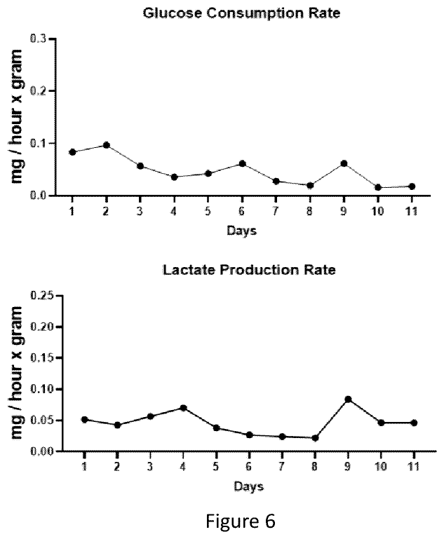

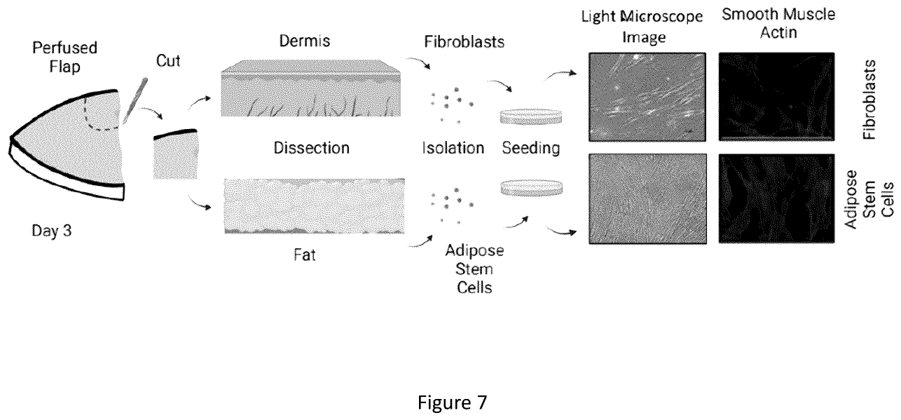

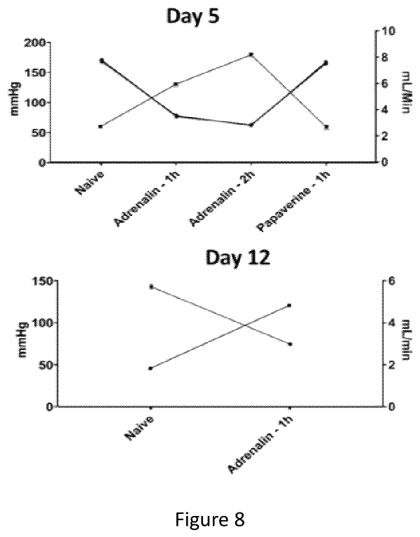

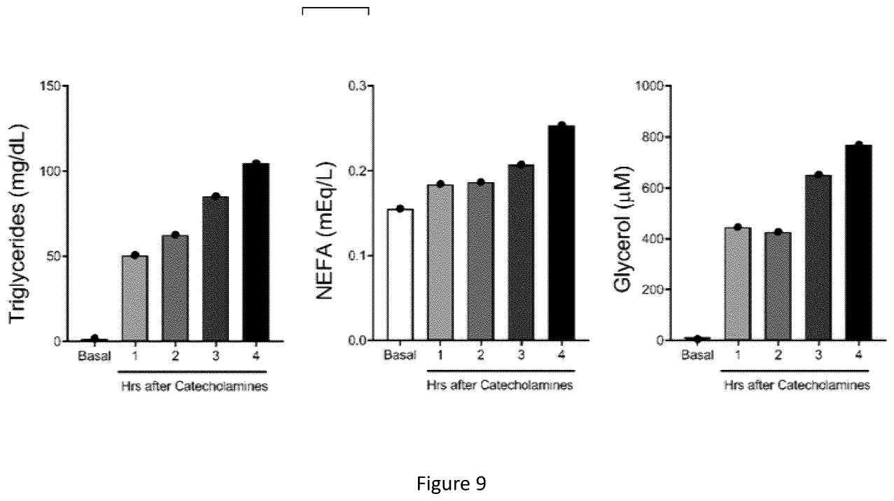

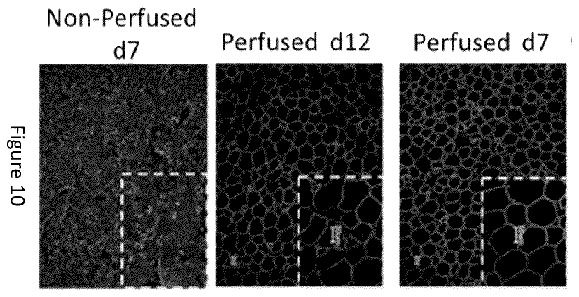

There are two main perforator systems for the abdominal pannus tissue (1) DIEP (deep inferior epigastric perforator) and (2) SIEA/SIEV. Most panniculectomy procedures retain only a portion of the DIEP, resulting in inefficient perfusion, so the SIEA/SIEV system was used for perfusion (FIG. 2). Cannulation and perfusion through the SIEV/SIEA system resulted in 80-90% tissue area being perfused as confirmed by fluorescein angiography (FIG. 3). The whole perfusion ran up to 3 weeks and was carried out under sterile conditions in a class II biosafety hood. The disclosed perfusion bioreactor is a fully automated digital system capable of real-time monitoring and recording of pH, flow rate, temperature, and pressure readings. The bioreactor system can be operated, and the parameters adjusted remotely. The disclosed perfusion protocol uses an optimized perfusion solution (DMEM+5% bovine serum albumin) and results in maintaining the tissue architecture anatomically and histologically (FIGS. 4A and 4B). The viability of the cells in perfused tissue was confirmed by TUNEL (Terminal deoxynucleotidyl transferase dUTP nick end labeling) staining for cell death. Confocal microscopy of the sections revealed almost 95% of the cells were healthy and viable up to day 12 post-perfusion, while in control, non-perfused tissue, almost all the cells were dead (TUNEL; Red) by day 7, and the epidermis was detached (FIG. 5). The glucose utilization and lactate production were monitored by the perfused tissue, and steady metabolic dynamics were observed (FIG. 6). To further confirm the viability of perfused tissue, adipose-derived stem cells and skin resident fibroblasts were isolated from perfused tissue on day 7 post-perfusion, and the viability of isolated cells was assessed. Results revealed no significant differences in the viability of cells isolated from fresh tissue or perfused tissue at day 7, while no viable cells were present by day 3 in non-perfused control tissue. Isolated cells showed normal proliferation dynamics and morphology, confirmed by light microscopy imaging and fluorescent phalloidin staining for actin filaments (FIG. 7). To further confirm the viability of perfused tissue, adipose-derived stem cells and skin resident fibroblasts were isolated from perfused tissue on day 7 post-perfusion and analyzed the viability of isolated cells. Results revealed no significant differences in the viability of cells isolated from fresh tissue or perfused tissue at day 7, while no viable cells were present by day 3 in non-perfused control tissue. Isolated cells showed normal proliferation dynamics and morphology, confirmed by light microscopy imaging and fluorescent phalloidin staining for actin filaments (FIG. 7). The health of the vascular system of perfused tissue was confirmed by adding adrenaline (vasoconstrictor) on day 5 or 12 post-perfusion and observed an increase in the pressure (mmHg) and a decrease in the flow rate (ml/min) confirming the physiological response of the endothelial cells (FIG. 8). As full thickness human tissue was used, the metabolic viability of the deeper adipose layer was also confirmed. The lipolytic response of adipocytes challenged with catecholamine on day 12 post-perfusion was assessed. Triglycerides, non-essential free fatty acids, and glycerol measurements in the perfusion media showed a gradual increase in levels with time, confirming a physiological lipolytic response (FIG. 9). The health of adipocytes was also confirmed by immunofluorescence staining for the perilipin protein (FIG. 10).

The disclosed optimized media and perfusion parameters allow to establish a novel and reproducible human full-thickness skin perfusion system that maintains tissue viability and physiological function. The disclosed platform can be used to assess the mechanisms of vesicant injury and test countermeasure strategies directly in human tissue.

### Example 2: Human Skin Perfusion System as a Model to Study Chemical Vesicant-Induced Injuries and Develop Countermeasures

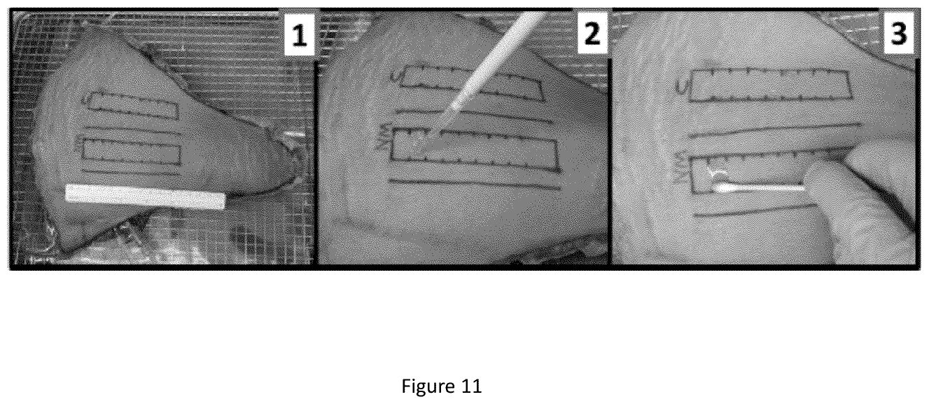

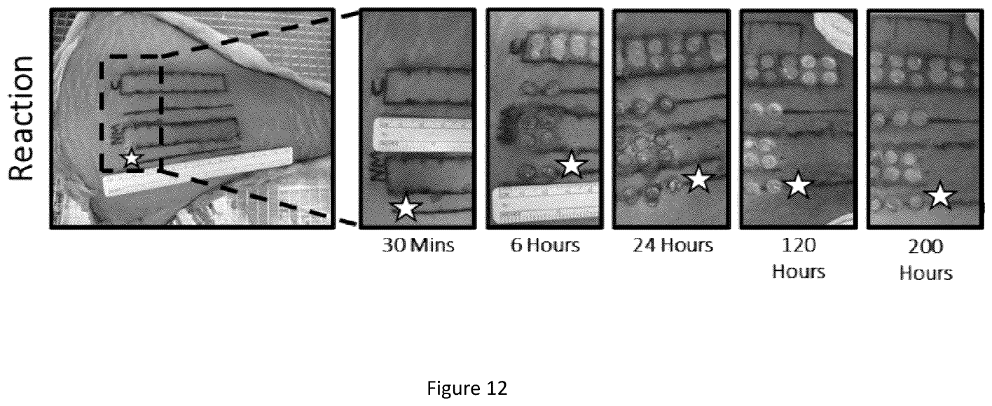

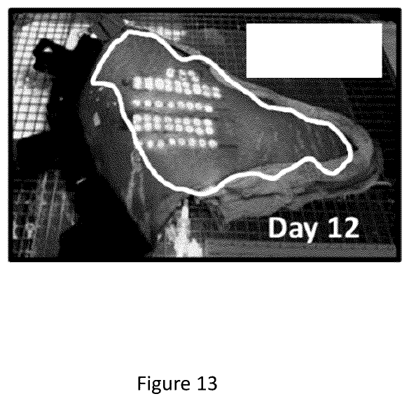

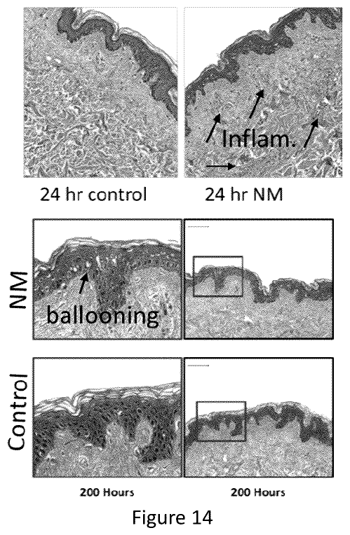

Nitrogen mustard (NM) induces transepidermal water loss, pyknosis, spongiosis, focal dermal-epidermal split, and perivascular and interstitial lymphocytic inflammation. An initial dose of 3 mg/cm² of NM was tested, but no visible effects were seen. Therefore, a higher dose was tested in an attempt to induce damage. Perfused full-thickness human skin tissue was treated with a 30 mg/cm² dose of NM in acetone or acetone alone (control) on day 5 after the start of the perfusion with a sterile cotton applicator as shown in FIG. 11. Transepidermal water loss was prominent as early as 30 minutes post-application indicated by a white star (FIG. 12). Biopsies were collected for histology, immunofluorescence, and gene expression analysis. Skin punches were evident in frames from 6 to 200 hours. Fluorescein angiography on day 12 confirmed the maintenance of perfusion (FIG. 13). Pyknosis, ballooning, and focal dermal-epidermal split (200 hr post-treatment) were observed in the NM-treated skin section. Perivascular and interstitial lymphocytic inflammation were noted with a prominence at 24 hr in NM-treated skin specimens (FIG. 14).

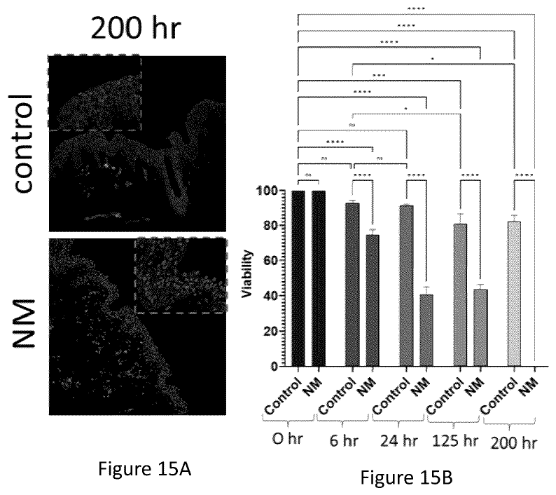

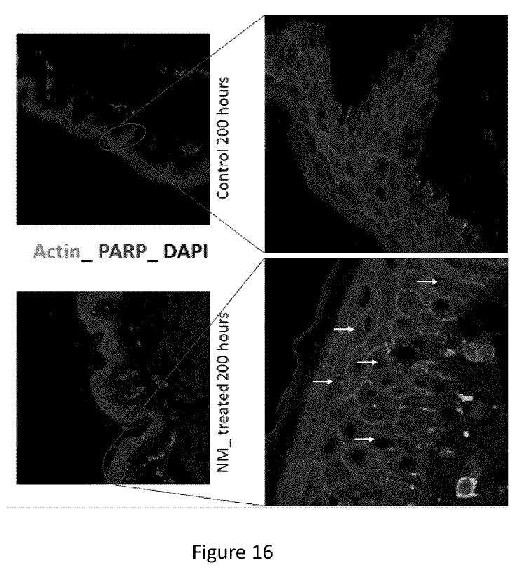

NM-induced cell death paralleled with an increase in PARP Staining. A gradual increase in TUNEL-positive (Red) cells with almost all the epithelial cells was observed in NM-treated skin patch positive by 200 hr (FIG. 15A, B). In parallel, an increase was observed in the PARP-positive cells (FIG. 16).

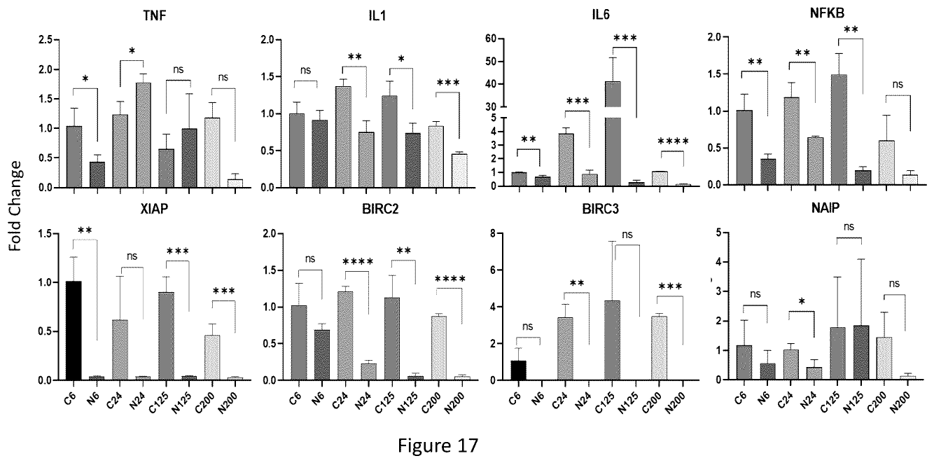

NM-treatment inhibits inflammatory and pro-survival gene expression. Genes indicative of inflammation and apoptotic response were assessed (FIG. 17). Results demonstrated an initial upregulation of TNFα only at 24 hours time point, but other inflammation-related genes, IL1α, IL-6 and NFκB, were significantly down-regulated. In addition, a pronounced lowering of anti-apoptotic genes was observed at almost all the time points analyzed (FIG. 17). Changes in gene expression in the control skin patch indicated a stable response.

NM treatment induced histological changes and cell death in perfused human skin, which are characteristic of sulfur mustard exposure. The gene expression profiling indicates an interesting trend toward anti-inflammation and survival. The single-cell gene analyses of migrating cells to the injury site will reveal many mechanistic insights. Accordingly, the disclosed human skin perfusion model is poised to be an excellent platform for studying vesicant-induced injuries. This platform can offer a great opportunity to rigorously compare published results using state-of-the-art techniques in human tissues.

### Example 3: Human Skin Perfusion System as a Model to Assess the Radiation-Induced Injury

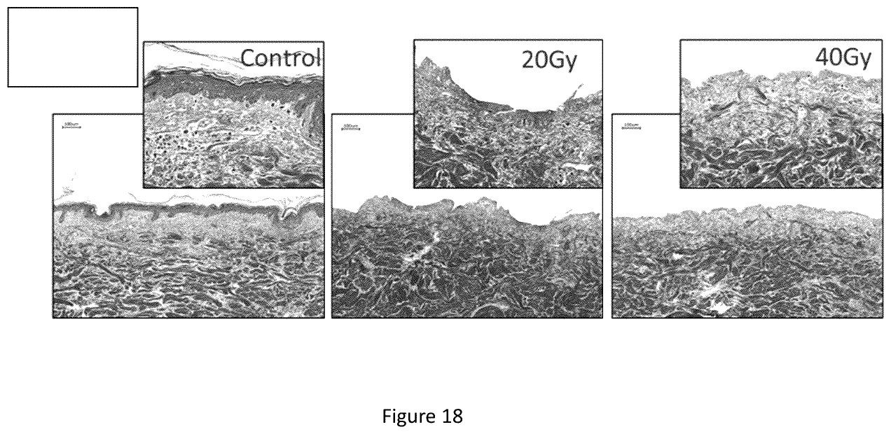

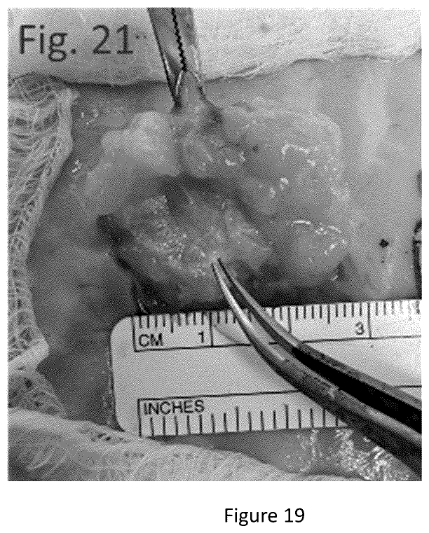

To test the utilization of perfused skin flap as a radiation injury model, the perfused skin was exposed to 20 and 40 Gy (gray) irradiation doses (FIG. 18). On day 12 post-irradiation, Masson's Trichrome stained sections revealed epidermal-dermal separation and accumulation of collagens in 20 and 40 Gy irradiated skin patches validating the disclosed model for radiation-induced injury (FIG. 19).

### Example 4: Tumor Growth Using the Disclosed Skin Perfusion System

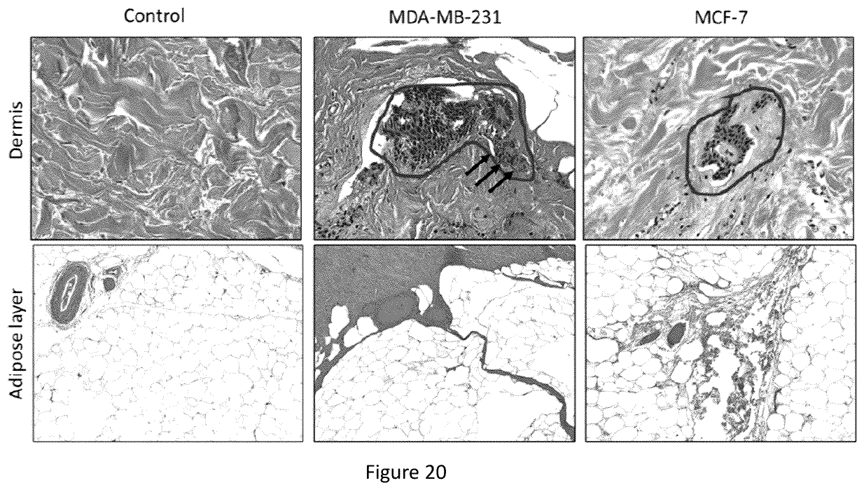

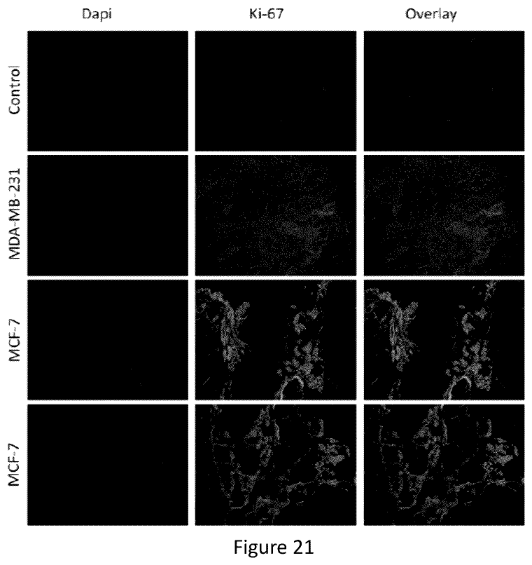

MCF-7 and MDA-MB 231 robustly form a tumor in the disclosed flap perfusion model. 3×10⁵ MCF-7 or MDA-MB-231 breast cancer cells were grown as spheroids in ultra-low attachment 6-well plates. Spheroids collected from one well were used for injection subcutaneously at 3 hours after the start of flap perfusion. Robust integration and tumorigenesis of MCF-7 and MDA-MB 231 cells were observed at day 6 post-inoculation. H&E sections confirmed the presence of growing tumors and metastasis in the underlying adipose tissue (FIG. 20). Dapi (nuclear stain, Blue) and Ki-67 (proliferation marker, Green) staining confirmed the presence of proliferating tumor cells (FIG. 21). Immune cell infiltration was observed upon tumor cell injection shown with arrows for MDA-MB-231 cells (FIG. 20).

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A system for perfusing a target tissue comprising:
a processor including an artificial intelligence (AI) module; and
a bioreactor, wherein the bioreactor comprises:
a media reservoir for storing media,
a peristaltic pump for transferring the media,
a perfusion chamber for culturing the target tissue with the media, and
a plurality of sensors;
wherein the perfusion chamber, the peristaltic pump, and the media reservoir are coupled through a tubing; and wherein the processor is configured to generate periodic reports on a metabolic rate of the target tissue through the plurality of sensors and control an operation of the bioreactor using the AI module for extending a perfusion period.

2. The system of claim 1, wherein the plurality of sensors comprises at least one of a pressure sensor, a flow sensor, a manometer, a pH sensor, a glucose sensor, a lactate sensor, a perfusate gas sensor, an electrolyte sensor, an infrared thermal camera, a temperature sensor, or combinations thereof.

3. The system of claim 1, wherein the bioreactor further comprises:
a transfer unit for transferring the target tissue,
a catheter,
a visible light spectrum camera,
a gas exchanger,
a luer connector, and
a heater for adjusting a temperature of the media, wherein the processor is configured to control operation of the transfer unit, the visible light spectrum camera, the gas exchanger, and the heater.

4. The system of claim 1, wherein the periodic reports on the metabolic rate are generated based on information obtained through the plurality sensors, wherein the information comprises lactate and glucose levels, pH levels, perfusate gas, electrolyte levels, arterial and venous flow rates, or combinations thereof.

5. The system of claim 1, wherein the processor is configured to report an error that arises due to an operator or an equipment failure.

6. The system of claim 1, wherein the processor is configured to automatically protect the target tissue based on a predetermined protocol or one or more machine-learning models of the AI module.

7. The system of claim 6, wherein the predetermined protocol is configured to minimize a failure risk.

8. The system of claim 6, wherein the one or more machine-learning models comprise at least a deep learning algorithm.

9. The system of claim 2, wherein the processor is configured to visually track a perfusion area via the infrared thermal camera.

10. The system of claim 1, wherein the AI module is configured to calculate a perfusion area, a media volume, a pump efficiency, an error that leads to a perfusion failure, or combinations thereof.

11. The system of claim 10, wherein calculating the perfusion area, the media volume, the pump efficiency, the error that leads to the perfusion failure, or combinations thereof is based on one or more inputs to the AI module, and wherein the one or more inputs comprise one or more of a flow rate, a pressure reading, a temperature reading, a CO2 saturation reading, a pH reading, or a number of bubbles.

12. The system of claim 10, wherein the error comprises an inline air, an excessive pressure, an edema, a deepithelization, a skin color change, an infection, or combinations thereof.

13. The system of claim 1, wherein controlling the operation of the bioreactor using the AI module comprises:
receiving, by the AI module, one or more sensor signals from one or more first sensors of the plurality of sensors;
determining, by the AI module, one or more operation instructions for one or more of the peristaltic pumps or one or more of the sensors; and
sending, by the AI module to the one or more of the peristaltic pumps or one or more of the sensors, the one or more operation instructions.

14. The system of claim 1, wherein the media comprises an active agent, wherein the active agent comprises an anti-inflammatory agent.

15. The system of claim 14, wherein the anti-inflammatory agent comprises prednisone, prednisolone, cortisone, hydrocortisone, triamcinolone, dexamethasone, mometasone, or a combination thereof.

16. The system of claim 1, wherein the target tissue comprises a skin, a flap, a tumor, a cancer, or combinations thereof.

17. The system of claim 1, wherein the media comprises Dulbecco's Modified Eagle Medium (DMEM) with bovine serum albumin (BSA) for maintaining a tissue architecture of the target tissue.

18. A method for perfusing a target tissue comprising:
transferring the target tissue to a bioreactor with media, wherein the bioreactor comprises a bubble trapping system, a heater, and a gas exchanger system; and
controlling operations of the bubble trapping system, the heater, and the gas exchanger system to control temperature, humidity, and air infusion in the bioreactor for maintaining a sterility, a cannulation of a vascular structure of the target tissue, pH levels, osmolarity, or combinations thereof, wherein the operations of the bubble trapping system, the heater, and the gas exchanger system are controlled by a processor including an artificial intelligence (AI) module.

19. The method of claim 18, further comprises treating the target tissue with a sterilizing agent to prevent infections.

20. The method of claim 18, further comprises infusing an active agent into the bioreactor, wherein the active agent comprises an anti-inflammatory agent.

21. The method of claim 18, further comprises generating periodic reports on a metabolic rate based on an analysis of information obtained through a plurality sensors by the AI module, wherein the information comprises lactate and glucose levels, pH levels, perfusate gas, electrolyte levels, arterial and venous flow rates, or combinations thereof.

22. The method of claim 18, further comprises perfusing the target tissue at least for 1 day.
